(19) United States
(12) Patent Application Publication
(10) Pub. No.: US 2018/0310698 A1
(43) Pub. Date: Nov. 1, 2018

(54) BULLETPROOF BACKPACK DESIGNED FOR PERSONAL SECURITY AND TRIGGERING DATA COLLECTION

(71) Applicant: BINDU RAMA RAO, LAGUNA NIGUEL, CA (US)

(72) Inventor: BINDU RAMA RAO, LAGUNA NIGUEL, CA (US)

(21) Appl. No.: 16/028,825

(22) Filed: Jul. 6, 2018

Related U.S. Application Data
(63) Continuation-in-part of application No. 15/293,288, filed on Oct. 14, 2016.
Application No. 15/293,288 is a continuation-in-part of application No. 15/216,696, filed on Jul. 22, 2016.

(51) Int. Cl. A45F 4/02; A45F 3/04; F41H 5/007; F41H 5/04; F41H 5/013; G08B 25/01; G08B 13/196; H04N 21/2187

(52) U.S. Cl. CPC A45F 4/02; A45F 3/04; F41H 5/007; F41H 5/0471; A45F 2003/003; G08B 25/016; G08B 13/19695; H04N 21/2187; F41H 5/013

(57) ABSTRACT

A bulletproof/ballistic resistance backpack to be used for personal safety while travelling or going to school, designed for convenience. It holds school books and computers, for a student, and a traveler's items, including a mobile phone, tablets and camera for a traveler. It helps store the traveler's items safely, conveniently and also helps charge them on-the-go. It is made of strong material to provide slash resistance, durability and ease of mind during travel.

### CROSS REFERENCES TO RELATED APPLICATIONS

The present patent application is a continuation-in-part (CIP) of, claims priority to, and makes reference to United States non-provisional patent, entitled BAG DESIGNED FOR CHARGING ELECTRONIC DEVICES ON-THE-GO, U.S. Ser. No. 15/293,288, filed 14 Oct. 2016, attorney docket number SECUREBAG03, which in turn is a continuation-in-part (CIP) of, claims priority to, and makes reference to United States non-provisional patent, Ser. No. 15/216,696 filed on 22 Jul. 2016, entitled “BAG FOR HOLDING TRAVEL ITEMS, DESIGNED FOR CONVENIENCE”, docket number SEKURT-01. The complete subject matter of all the above-referenced United States patent applications is hereby incorporated herein by reference in their respective entirety.

### BACKGROUND

### 1. Technical Field

The present invention relates generally to bags used to carry items for school or travel, and specifically to strong bags that can also provide personal safely and conveniently store user's electrical devices.

### 2. Related Art

Kids carry a lot of books to school and they also carry laptops and tablets sometimes. Safety of the items carried is important and backpacks can provide them to some extent. However personal safety is also very important, if not more important, and backpacks today cannot provide them. Knife attacks on kids and shooting in schools make it clear that personal safety is always an issue and danger does lurk even in schools.

People have been travelling for ages. Travel for fun or for business has become a common activity. People of late have been carrying mobile phones with them, often taking their mobile phone chargers with them. Similarly, most travelers carry cameras and camcorders with them on their journey, and they pack additional chargers for those cameras and camcorders. When a person travels abroad, that person often takes power adapters with them, and quite often several different power adapters, one for each electrical device, such as the mobile phone, the camera, the hair dryer, etc. These plethora of chargers, cables, power adapters, one for each electrical device packed by the traveler, add to the complexity of packing for a trip, and add to the total luggage weight.

Often, a traveler unpacks all his electrical devices at the end of a day of travel, and back at the hotel, in order to charge them for the next day of use. This involves locating several different power outlets, one for each electrical device to be charged, and then bringing out the charging cables, hooking them up to the electrical devices, and plugging the other end of the charging cables into power adapters (as necessary) before plugging the power adapters into wall sockets. This rigmarole is repeated in reverse order the next day in the morning to repack all those cables, the plurality of power adapters, the wall sockets, and the devices. Often a traveler forgets to repack some of those cables, power adapters and devices, only to realize much later that those items have been left behind at the hotel.

Pickpocketing is a problem in quite a few places where people tend to visit. Pickpockets can be found in several cities and even in rural places all over the world, and losses due to theft are quite devastating to some travelers. For example, a pickpocket may cut open a traveler's bag and steal a purse full of cash and credit cards without the traveler discovering the loss much later. Thieves have been known to slash bags even without the traveler noticing such activities, or realizing that her belongings are being stolen.

There is a need for better bags that are more secure, and more convenient. There is a need for bags that provide the user the ability to easily handle unpacking and repacking at hotels.

Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a backpack for carrying school books by kids and travel items by travelers wherein the backpack provides a bulletproof backpanel and several sections for storing books and electronic items;

FIG. 2 is a perspective block diagram of a multi-pocket backpack, that comprises a bulletproof backpanel, a front pocket section for storing pens, keys, tickets, etc., a front top section to store small electronics, wires, cables etc., and a main section with a zippered opening to store laptops, tablets, powerbank chargers, etc.;

FIG. 3 is a perspective block diagram of the inside of a multi-pocket backpack with a bulletproof backpanel, the backpack comprising a first pocket for storing a powerbank charging device, a second pocket configured to hold a mobile device and a third pocket 335 configured to hold one of a camera and a camcorder;

FIG. 4A is a perspective block diagram of a section of the backpack with its backpanel cut through to expose several layers of plates;

FIG. 4B is a perspective block diagram of a crosssection of the backpanel of the backpack built in accordance with the present invention;

FIG. 5A is another perspective block diagram of the backpanel of the backpack built in accordance with the present invention wherein the backpanel also comprises a processor, a NFC circuitry for local near field communications, a GPS circuitry for determining geolocation coordinates, and a power connection through which power is available as required for the processor, the NFC circuitry and the GPS circuitry;

FIG. 5B is another perspective block diagram of the backpanel of the backpack built in accordance with the present invention wherein the backpanel has multiple layers, each layer comprising a thin plate that is made stronger by a reinforced Kevlar sheet to which a magnetorheological fluid layer is added; and

FIG. 6 is a perspective block diagram of electronics circuitry provided by the backpack comprising a processor communicatively coupled to a wife/NFC communication circuitry and a GPS circuitry over a bus in order to provide data collection, status monitoring, live streaming and remote triggering and command support.

### DETAILED DESCRIPTION OF THE DRAWINGS

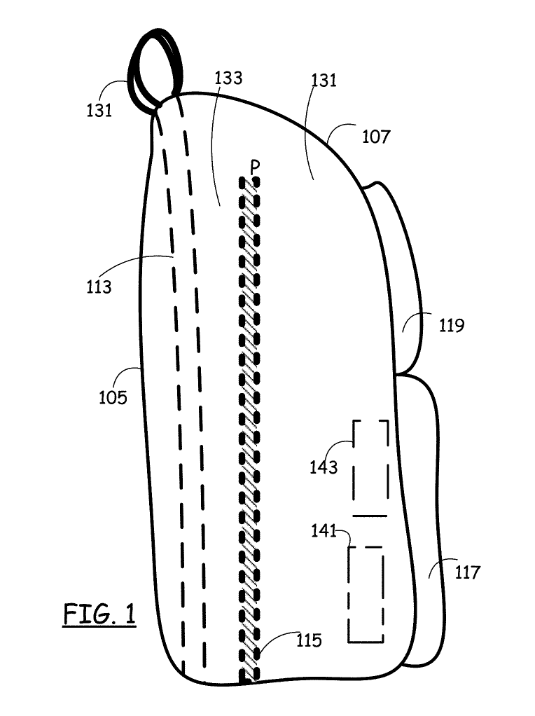

FIG. 1 is a perspective block diagram of a backpack 105 for carrying school books by kids and travel items by travelers wherein the backpack 105 provides a bulletproof backpanel 113 and several sections for storing books and electronic items. It also provides remote alerting and data collection capabilities based on triggers, commands (local or remote) and voice interactions.

The backpack 105 defines a storage volume, wherein the backpack 105 (sometime referred to as a luggage bag) comprises a plurality of walls, wherein those of the plurality of walls constituting the outer walls 121 comprise a slash resistant material layer 107. Thus, the items inside the backpack 105 are not easy to steal by pickpockets and thieves who often try to silently make a cut or tear in the bag without the traveler/user noticing it. The backpack 105 also comprises a powerbank portable charging device 141 in some configurations, wherein the powerbank portable charging device 141 supplies power from its built-in batteries through a plurality of ports and attached charging cables (USB ports for example).

The backpack 105 also comprises pouches to safely store a mobile device, a camera, a laptop, etc. The backpack 105 also provides a communication and location circuitry 143 that not only determines a location (such as GPS location) but also communicates backpack status, powerbank portable charging device 141 charging status, environmental conditions (such as heat, moisture, etc.) backpanel 113 status etc.

In one configuration, the communication and location circuitry 143 reports the status of the backpanel 113, wherein the status comprises environmental conditions, the wear and tear effect/estimated, the number of ballistic shots the backpanel 113 may have received, the time and location of when and where such ballistic shots might have been received, approximate impact location of the ballistic shots on the backpack, etc. Using near field communications, WIFI, infrared (IR) and cellular means, the communication and location circuitry 143 reports the status of backpack backpanel 113. For example, using NFC means the backpanel 113 reports to a mobile device of the user the status of the backpanel 113.

The communication and location circuitry 143 draws electrical power as necessary from the powerbank portable charging device 141 to which it is electrically and communicatively coupled. It is coupled to one or more cameras attached to the backpack 105 is some configurations and helps communicate photos, audio data collected, and videos when those cameras are activated for data collection. Such cameras are attached (or come attached) to the front side, the backside and other places on the backpack 105. The communication and location circuitry 143 communicates GPS coordinates of the backpack 105, along with data collected by these cameras. Data collection is triggered by monitoring circuitry in some configurations and upon user instruction in some others. They are initiated by remote triggers in some configurations.

The backpanel 113 covers and protects the entire backside of the backpack 105, end-to-end. When worn on the backside of a user, the backpanel protects the backside of the user. When worn across the user's chest, the backpanel protects the front side of the user.

The communication and location circuitry 143 is incorporated into the backpanel 113 in some configurations, incorporated into the powerbank portable charging device 141 (also referred to as the powerbank charger in some configurations) is other configuration, and into the construction of the backpack 105 itself is yet other configurations.

In one configuration, the powerbank charger 141 in the backpack 105 records and stores (such as for live transmission, sharing or backup), sounds collected, photos and videos from the connected cameras (provided as part of the bag or attached later). The powerbank charger 141 in the backpack 105 also communicates and/or stores photos and videos collected from a mobile phone, photos and videos from the connected camera(s), and photos and videos from the connected tablet device. For example, the powerbank charger 141 comprises memory, storage and communication circuitry that enables it to receive and store all photos and videos transferred/communicated by the connected cameras, mobile phone, tablet (APPLE ipad, etc.), and camera(s) that it is currently connected to. It is capable of sharing such transferred photos and videos with websites, video servers, social groups, social networks, YouTUBE network, Facebook network, etc. It is capable of uploading transferred photos and videos with Google websites, Google photos network, etc. The devices (camera, mobile phone, tablet, etc.) can then automatically delete those transferred photos and videos thereby making more memory/storage available for additional photos, data, videos, etc.

Elastic bands that help secure devices such as the powerbank charger 141 in the backpack 105 are provided. In addition, device holders pockets are also provided, pockets with zippers that securely house any electrical or non-electrical devices placed inside are also provided in the backpack 105.

The in the backpack 105 now makes it possible to
Protect parts of the user's body from harm due to ballistic shots
Monitor the environment around the user and the backpack
Obtain photos, audio and videos from the surroundings of the back 105
Charge electrical devices on the go, as they are securely housed in pockets in the bag and the powerbank portable charging device provides recharge capabilities even when mobile (in trains, planes, running etc.)
Security and safety provided—Slash resistant backpack which pickpockets and thieves will find very hard to slash, cut, etc. to steal items inside
RFID and credit card safe—EMF protection to make sure identity thieves and credit card thieves do not get hold of digital data in credit cards, passports and identity cards
In addition, in some embodiments, the pockets are made of anti-bacterial and anti-microbial material, such that bacteria, mold and fungus does not grow in pockets, even in places where humidity is relatively high.

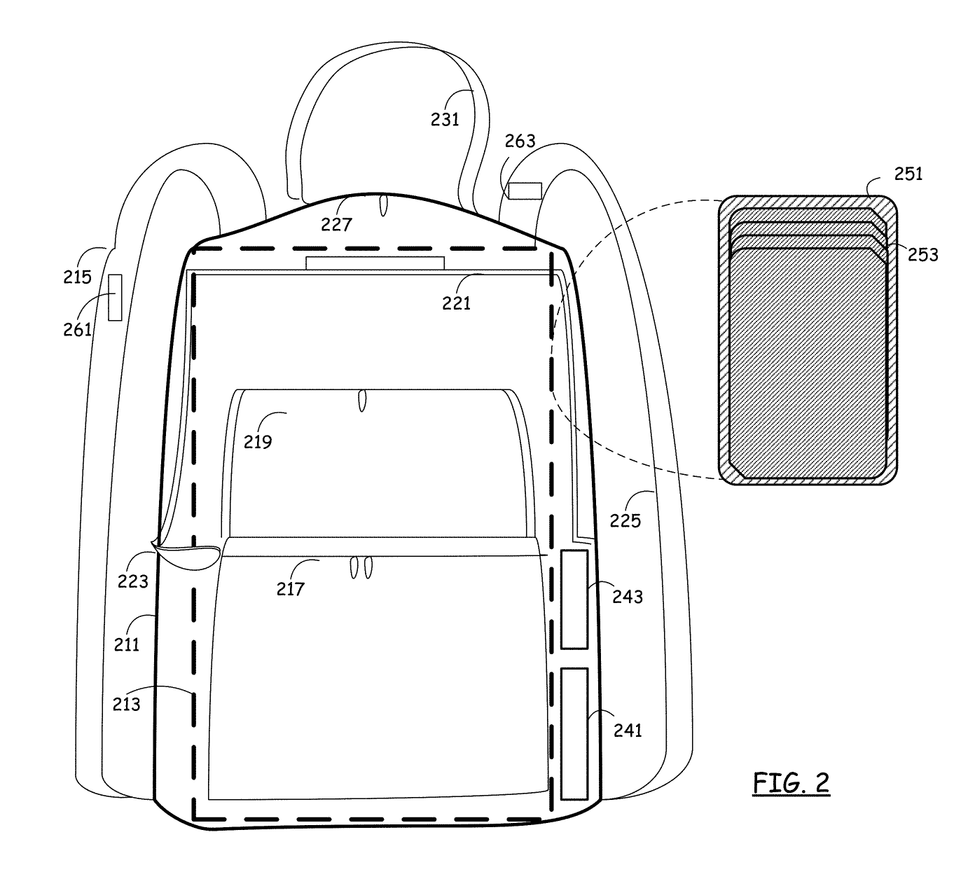

FIG. 2 is a perspective block diagram of a multi-pocket backpack 211, that comprises a bulletproof backpanel 213, a front pocket section 217 for storing pens, keys, tickets, etc., a front top section to store small electronics, wires, cables etc., and a main section with a zippered opening 221 to store laptops, tablets, powerbank chargers 241, etc. The bulletproof backpanel 213, sometimes referred to as the ballistic resistance panel too, comprises a main covering 251 within which a plurality of ballistic resistance plates 253 are provided. Together, these ballistic resistance plates 253 protect the user of the backpack 211 and a portion of the user's body covered by the backpack 211 is protected from serious harm from ballistic shots.

The backpack 211 has cameras 261, 263 built-in to capture and communicate photos, audio and live streaming videos, as necessary. Such communication from cameras is through wireless means, wired means or both, based on needs and conditions. Several other locations for additional cameras are also contemplated, such as cameras on the backside, cameras inside, cameras on the sides, etc. Not all cameras need to be active at any given time. Data collection using these cameras is triggered by user actions, by voice commands by user, by remote activation, etc.

The backpack 105, 211 with shoulder straps 215, 225 is capable of being used on one's back, as well as being used with the backpack covering a user's chest. The straps 215, 225 allow it to be carried on one's back or across one's chest. The backpack 211 comprises a bulletproof panel 213 integrated into a backside of the backpack, that provides ballistic resistance and personal security, and an electronic circuitry 243 incorporated into the backpack that facilitates near-field and wifi communications, automated and triggered mode monitoring, data collection and processing, and live streaming. It also comprises a powerbank charger 241 for charging the electronic circuitry 243. The powerbank charger 241 also charges a plurality of electronic devices stored in the backpack 211. The electronic circuitry 243 monitors the status of the bulletproof panel 213 and reports changes in the status of the bulletproof panel 213.

In one configuration, the backpack 211 provides a plurality of pouches to hold the plurality of electronic devices, each of the plurality of pouches (217, 219, 333, 335) configured inside the backpack 211 so as to safely and securely house, and narrowly fit, a corresponding one of the plurality of electronic devices while it is being charged by the powerbank charger 241. The bulletproof panel 213 comprises a plurality layers 253 of ballistic resistant material enclosed within a case 251. Each of the plurality of layers 253 of ballistic resistant material enclosed within a case 251 comprises one of a Kevlar fabric piece, an ultra high molecular weight polyethylene piece, and a polyethylene plate. These plurality of layers provide the ability to stop a bullet making the user relatively safer while wearing/carrying the backpack 211. In a related configuration, each of the plurality of layers 253 of ballistic resistant material enclosed within a case 251 comprises a Kevlar fabric piece coated with a shear-thickening fluid.

In another configuration, at least one of the plurality of layers of ballistic resistant material 253 enclosed within the case 251 comprises a thin pouch of magnetorheological fluid that changes its ballistic resistance when subjected to a magnetic field provided. The case 251 comprises an electrical coil or mesh, that when provided with electrical power from the powerbank charger 241, generates a magnetic field sufficient to cause the thin pouch of magnetorheological fluid to harden enough to provide ballistic resistance.

In yet another configuration of the backpack 211, 105 a plurality of cameras 261, 263 are provided, wherein each of the plurality of cameras are communicatively coupled to the electronic circuitry 243. When triggered, plurality of cameras 261 263 collect audio and video data and communicate it to an external receiver via the electronic circuitry 243. The triggering can be by the user flipping a switch or providing an audio command. The triggering can be remote by means of a command received by the electronic circuitry from an authorized external source/server. In a related embodiment, the electronic circuitry 243 of the backpack 211 comprises a processor 621 communicatively coupled to a communications circuitry 613, wherein the communications circuitry 613 is capable of NFC and wifi communications for communicating data collected and streaming videos (such as those taken by a camera communicatively coupled). The processor 621 is communicatively and electrically coupled the powerbank charger 241 (also 617) for electrical power. The processor 621 facilitates near-field and wifi communications employing the communications circuitry 613 conducts automated and triggered mode monitoring, data collection, and live streaming employing video streams collected by the cameras disposed on the backpack 211.

In a different configuration, backpack 211, 105 comprises shoulder 215, 225 straps that allow it to be carried on one's back or across one's chest, and the backpack 211 comprises a bulletproof backpanel 213 that provides personal security. The backpack 211 also comprises a processor 621 (for example as part of the electronic circuitry 243) communicatively coupled to a communications circuitry 613, wherein the communications circuitry 613 is capable of NFC and wifi communications. The processor 621 communicates data collected and streaming videos created (on the fly) via the communications circuitry 613. The processor 621 triggers rheological behavior in the bulletproof backpanel 213 based on user activation, external commands or anticipated security threats. The processor 621, based on user trigger received, commences data collection and live streaming of video provided by a camera 261, 263 communicatively coupled to the processor 621. The backpack 211 also reports its current location (for example provided by the GPS circuitry 615) to an external server and to a mobile device.

The backpack 211 reports shots heard. The backpack starts and stops collecting and reporting data and video based on user commands and based on remote instructions received.

In a related configuration, the backpack 211 also comprises a RFID secure packet where credit cards and passports can be securely stored without the possibility of unauthorized access to their credit card numbers and passport data while they are being thus stored.

In yet another different configuration, the backpack 211, 105 is designed to provide personal security with a backpanel 213 made from a material for dissipating the kinetic energy of a moving object that impinges upon the backpack 211. The backpack 211, 105 comprises the backpanel 213 comprising a plurality of layers of the material 253l, each of the plurality of layers 253 of the material being additionally covered or impregnated with shear thickening fluid. The backpanel 213 also comprises a camera (such as camera 261, 263) communicatively coupled to the processor 621 to provide live streaming of video when triggered. The processor 621 is configured to activate data collection and camera live streaming automatically based on monitoring the environment, and also activation on receiving remote commands. The material is one of a kevlar fabric and ultra high molecular weight polyethylene plate in a related configuration. In another related configuration, the material is impregnated with particles suspended in a solvent and said particle-solvent suspension remains in a flowable form after impregnation. In yet another related configuration, the material for dissipating the kinetic energy of a moving object comprises a material which is made of fiber or yarn and said fiber or said yarn is impregnated with a shear thickening fluid wherein said shear thickening fluid remains in a fluid form in said material.

In one configuration, the backpack 211 comprises an audio command circuitry that monitors audio signals to detect commands and instructions (for example, with the help of the electronic circuitry 243) and upon detecting, triggers a corresponding activity. For example the user of the backpack 211 may say “alert” and the backpack responds by detecting “alert” to be a command and initiates data collection (for example sound, location, temperature, etc.) and automatic reporting. For a different example, other similar user commands that initiate calling a local police for help (say by sending a text message, a prerecorded message, etc.) and live streaming using available cameras, in addition to data collection, are “danger”, “help”, “police”, etc.

For example, in one configuration, the backpack 105,211 provides one main compartment 131 for books with a much smaller compartment 133 in the back to hold a laptop. An additional pouch is provided for a tablet such as an ipad. A soft panel (P) 115 separates the larger book section 131 from the smaller laptop section 133. (that also holds a tablet pouch). The zipper of the main compartment goes down to almost ⅔rd of the backpack height. The smaller padded tablet/ipad mini pouch on the back of the soft panel P is capable of safely storing/hosting an Apple iPad mini. A water bottle pocket 223 on left hand side when worn, and a padded aim & shoot small camera pocket on the right hand side (which can also be used to store laptop charger wires) are also provided. A front pocket with an organizer section 117, 217 to store a user's necessary gadgets and music player, and a headphone cord port, two thin pen pouches, are also provided. A strong handle 131, 231 with reinforced hold on the top of the pack makes it easy to hold in ones hand. A zippered accessory pocket 119, 219, in the front top of the backpack 105 right below handle, is also provided. A RFID proof credit card section inside the backpack's main Compartment on panel P makes it possible to safely store credit cards (say to hold 2 credit cards) or a passport if necessary, without making their digital contents accessible to electronic snoopers/scanners.

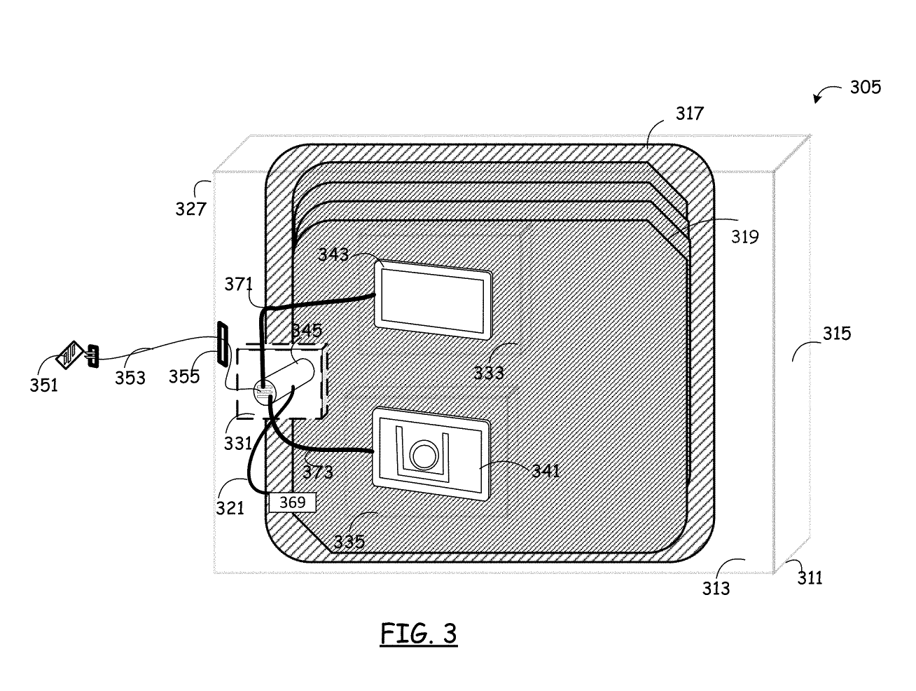

FIG. 3 is a perspective block diagram of the inside of a multi-pocket backpack 305 with a bulletproof backpanel 317, the backpack 305 comprising a first pocket 331 for storing a powerbank charging device 345, a second pocket 333 configured to hold a mobile device 343 and a third pocket 335 configured to hold one of a camera 341 and a camcorder.

In one configuration, multi-pocket backpack 305 further comprises slash resistant capabilities—the front and back opposing sidewalls each comprising a layer of slash resistant fabric. In another related configuration, the layer of slash resistant fabric comprises one or more layers of Kevlar-based fabric enhanced with shear thickening fluid. In yet another configuration, layer of slash resistant fabric comprises one or more of a Nomax aramid fabric, a nylon based fabric, a denier based fabric, or a combination thereof.

The multi-pocket backpack 305 comprises, in one configuration, a cable entry slot 355 close to the first pocket 331 for passing a cable 353 from an external power outlet 351 or device to the powerbank charging device 345.

The multi-pocket backpack 305, in another configuration, is configured to simultaneously hold in their respective pockets 331, 333, 335 the powerbank charging device 345, the mobile device 343 and the camera or camcorder 341, even as the powerbank charging device 345 in the first pocket 331 is used to simultaneously charge the mobile device 343 in the second pocket 333 and the camera or camcorder 341 in the third pocket 335.

The multi-pocket backpack 305, in another configuration, is configured to simultaneously hold in their respective pockets 331, 333, 335 the powerbank charging device 345, the mobile device 343 and the camera or camcorder 341 even as the powerbank charging device 345 is plugged into a external power outlet 351 or device for charging via a cable 353 passed through the cable entry slot 355, and the mobile device 343 and the camera or camcorder 341 are also at the same time plugged into the powerbank charging device 345 employing appropriate charging cables.

The multi-pocket backpack 305, in a different configuration, comprises a mobile charging cable 371 positioned along into the first sidewall exposing appropriate sockets at either ends, that enables charging of the mobile device 343 by the powerbank charging device 345. It also comprises a camera or camcorder charging cable 373 positioned along the second sidewall 325 exposing appropriate sockets at either ends enabling charging of the camera or camcorder 341 by the powerbank charging device 345.

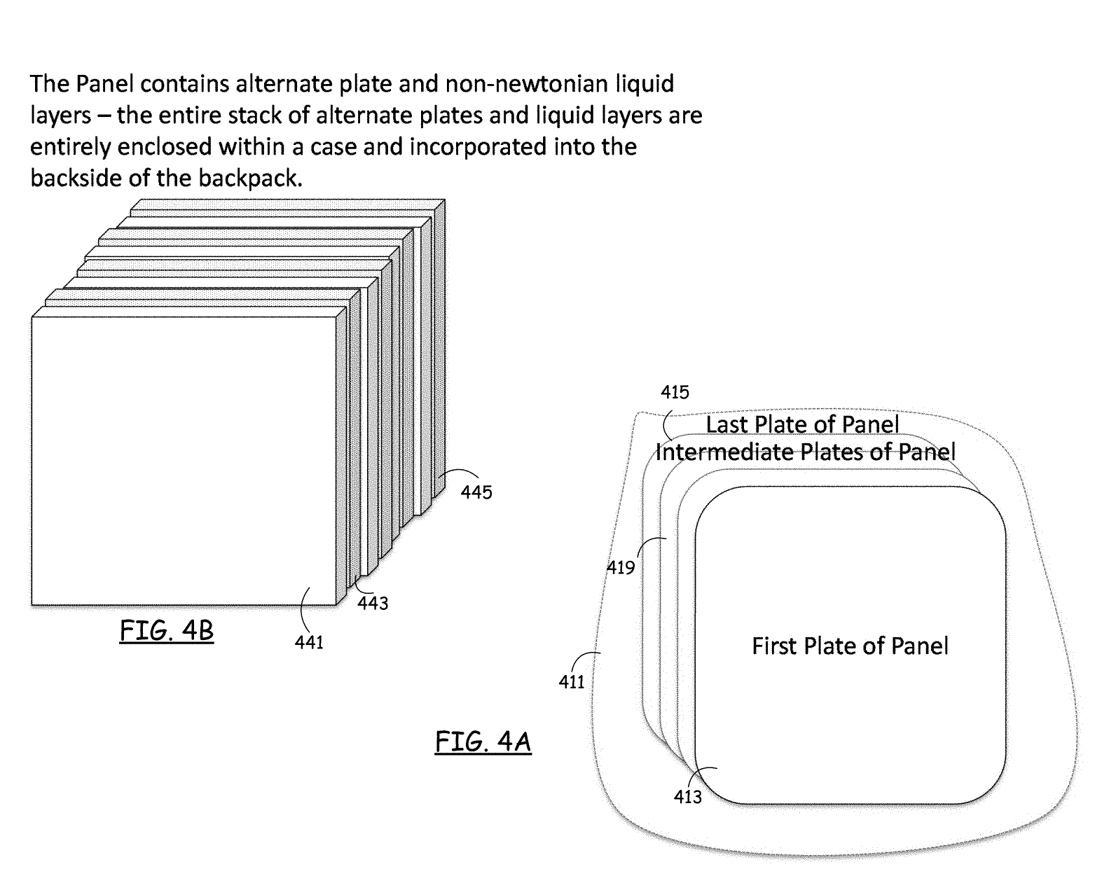

FIG. 4A is a perspective block diagram of a section of the backpack with its backpanel 411 cut through to expose several layers of plates. Between a first plate 413 of the backpanel of the backpack 405 and a last plate 415, there are several intermedia plates 419 that each contribute to the ballistic resistance of the backpanel 411.

FIG. 4B is a perspective block diagram of a crosssection of the backpanel of the backpack built in accordance with the present invention. The backpanel contains alternate plate and non-newtonian liquid layers 443—the entire stack of alternate plates between the first plate 441 and the last plate 445 are entirely enclosed within a case and incorporated into the backside of the backpanel.

In one configuration of the backpanel of the backpack, the backpanel contains a plurality of plates and ballistic resistant plates each covered in or processed with a non-newtonian liquid, and the entire stack of plates between the first plate 441 and the last plate 445 are entirely enclosed within a case and incorporated into the backside of the backpanel. For example each of the plates are UHMWPE type of thermoplastic polyethylene that display high impact strength and abrasion resistance, and they are coated with a layer of shear thickening fluid (STF) such as a mixture of polyethylene glycol (PEG) and silica (such as colloidal silica or silica in the form of nano particles). In another example, a kevlar fabric piece soaked in shear thickening fluid or a magnetorheological fluid constitutes each plate in the stack of plates comprised in the backpanel of the backpack.

In one configuration, each of the plates of the backpanel are UHMWPE type of thermoplastic polyethylene and one or more layers of magnetorheological fluid are also placed between some of the plates of the backpanel. The set of plates are then covered/surrounded by a layer of electrical wiring such that when current passes through them (activated by user, by software, or by remote commands) the magnetorheological fluid thickens making the backpanel extra hard and more resistant to ballistic shots. In a related configuration, the enclosing case around the set of plates also incorporates the surrounding layer of wiring that triggers the magnetorheological fluid thickening when necessary.

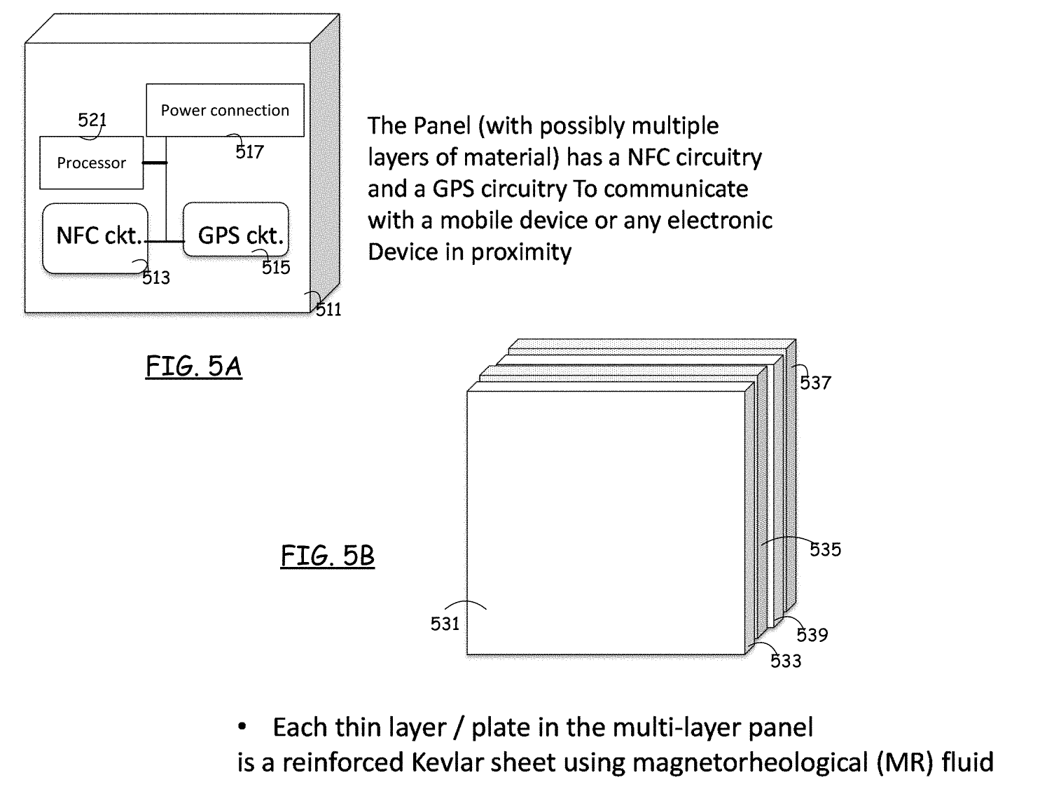

FIG. 5A is another perspective block diagram of the backpanel of the backpack built in accordance with the present invention wherein the backpanel also comprises a processor 521, a NFC circuitry 513 for local near field communications, a GPS circuitry 515 for determining geolocation coordinates, and a power connection 517 through which power is available as required for the processor 521, the NFC circuitry 513 and the GPS circuitry 515. The processor monitors the condition and status of the backpanel 511 and reports if shots are determined to have hit the backpanel 511, if the backpanel 511 is determined to have been damaged, etc. The NGC circuitry interacts with a mobile device in proximity and communicates the status of the backpanel, the location of the backpack, etc. In a related configuration, the processor 521, NFC circuitry 513 and the GPS circuitry 515 are all external to the backpanel 511.

FIG. 5B is another perspective block diagram of the backpanel of the backpack built in accordance with the present invention wherein the backpanel 531 has multiple layers, each layer comprising a thin plate 533, 539 (and others) that is made stronger by a reinforced Kevlar sheet 535 to which a magnetorheological fluid layer is added. Thus the individual ballistic resistant thin plates in the panel are each enhanced by use of a Kevlar sheet with magnetorheological properties 535 wherein the Kevlar sheet gets additional ballistic resistance in the presence of a magnetic field applied around it when required. In a related configuration, a Kevlar sheet with magnetorheological properties 535 is glued to each of the plates 531, 533 of the multi-layer backpanel of the backpack. In addition, each of the individual plates 531, 533 are themselves coated or covered with shear-thickening fluid in some other configurations.

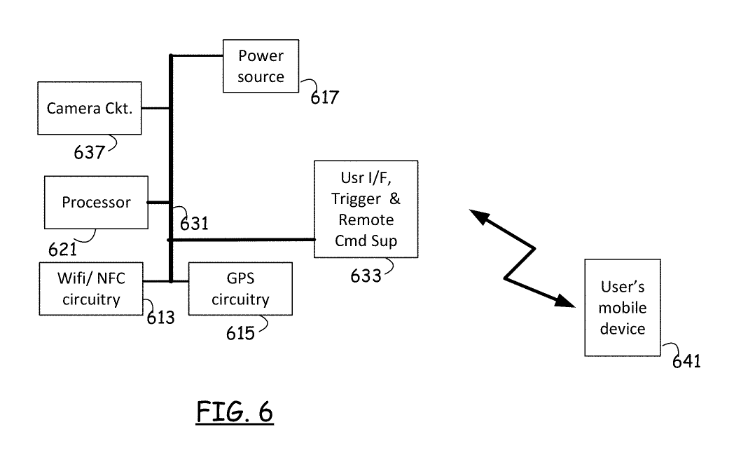

FIG. 6 is a perspective block diagram of electronics circuitry provided by the backpack 105 comprising a processor 621 communicatively coupled to a wifi/NFC communication circuitry 613 and a GPS circuitry 615 over a bus in order to provide data collection, status monitoring, live streaming and remote triggering and command support. The processor 621 is communicatively coupled to a camera circuitry 637 that is uses for live streaming, capturing images etc. The processor 621 is communicatively coupled to a user interface, trigger & remote command support circuitry 633 that provides user interface support to gather user initiation of data collection, user activation/inactivation of magnetorheological properties for enhanced ballistic resistance, etc. The user interface, trigger & remote command support circuitry 633 also provides remote command activation and triggering of activities such as camera 637 data capture based on triggering logic/configuration setup, etc.

The electronics circuitry provided by the backpack 105 comprising the processor 621 and other circuitry are builtin as part of the backpack 105 in one configuration. The processor 621 interacts with a mobile device 641 of the user of the backpack 105 via a downloadable mobile app that can be installed in the user's mobile device 641. If the backpack 105 is misplaced or lost, the camera circuitry 637 on the backpack is remotely triggered by the user using the mobile device app and the streaming video and photos provided by the camera circuitry 637 via the processor 621 to the user's mobile device 641 facilitate in locating the backpack. Similarly the backpack's location provided by the GPS circuitry 615 helps locate the backpack when it is lost of misplaced.

The electronics circuitry provided by the backpack 105 comprising the processor 621 and other circuitry are builtin as part of the powerbank charger 141 used in the backpack 105 in another configuration. The powerbank charger 141 interacts with a mobile device 641 of the user of the backpack 105 via a downloadable mobile app that can be installed in the user's mobile device 641. If the backpack 105 is misplaced or lost, the camera circuitry 637 of the powerbank charger 141 is remotely triggered by the user using the mobile device app and the streaming video and photos provided by the camera circuitry 637 via the processor 621 to the user's mobile device 641 facilitate in locating the backpack 105.

At times of danger, police or security personnel can remotely trigger data gathering, live streaming etc. from a remote server or from the mobile device 641. Similarly, when the user senses danger, the user can initiate data gathering by the electronics circuitry provided by the backpack 105 and also trigger calls for help and live streaming of video to a remote server or web site.

In one configuration, the user interface, trigger & remote command support circuitry 633 also comprises an audio/voice activation trigger circuitry that provides audio input monitoring and voice triggering of communication activation, data collection and live streaming activities, wherein data collection activities include audio data collection, image collection, transmission of such data, etc. For example, if a bullet shot is heard, the sound of the bullet automatically triggers data collection and live streaming for some default time (say 10 minutes) and such data collection, communication and live streaming continues based on local or remote instructions/commands. The user interface, trigger & remote command support circuitry 633 picks up sounds in the neighborhood analyses it and decides to trigger other actions if it determines there is a threat to the user of the backpack, or if it determines there is a need to collect data or start live streaming of videos from one or more cameras currently available (attached to the sockets on the backpack and communicatively coupled). Note these cameras are capable of wireless communication in short distances as well as live streaming via the wifi/NFC circuitry.

Automatic data gathering and live streaming based on patterns of user behavior and based on artificial intelligence logic are also contemplated.

As one of ordinary skill in the art will appreciate, the terms “cable” includes USB cables used to charge electronic devices, micro-USB cables, lightening cables, cables used to charge APPLE iphones, APPLE ipads, and other tablets, micro-USB cables used to charge digital cameras and camcorders, etc.

As one of ordinary skill in the art will appreciate, the terms “connected” and “electrically connected,” as may be used herein, include direct coupling and indirect coupling via another component, element, circuit, or module where, for indirect coupling, the intervening component, element, circuit, or module does not modify the charging function but may adjust its current level, voltage level, and/or power level.

As one of ordinary skill in the art will appreciate, the terms “narrowly fit” used for pouches includes a proper fit determined according to the known size of the devices to be stored in the respective pouches/pockets. Cameras and mobile phones have different sizes/dimensions, and their respective pouches need to be properly dimensioned to hold them relatively tightly, or appropriately, so that they are securely and safely housed, without getting jostled in loose pouches.

Although the present invention has been described in terms of USB based power charging of devices, other forms and techniques to charge electrical devices such as mobile phones and cameras are also contemplated.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A backpack with shoulder straps that allow it to be carried on one's back or across one's chest, the backpack comprising:
a bulletproof panel integrated into a backside of the backpack, that provides ballistic resistance and personal security;
an electronic circuitry incorporated into the backpack that facilitates near-field and wifi communications, automated and triggered mode monitoring, data collection and processing, and live streaming; and
a powerbank charger for charging the electronic circuitry;
the powerbank charger also charging a plurality of electronic devices stored in the backpack; and
the electronic circuitry monitoring the status of the bulletproof panel and reporting changes in the status of the bulletproof panel.

2. The backpack of claim 1 further comprising:
a plurality of pouches to hold the plurality of electronic devices, each of the plurality of pouches configured inside the backpack so as to safely and securely house, and narrowly fit, a corresponding one of the plurality of electronic devices while it is being charged by the powerbank charger.

3. The backpack of claim 1 further comprising:
the bulletproof panel comprised of a plurality layers of ballistic resistant material enclosed within a case.

4. The backpack of claim 3 wherein each of the plurality of layers of ballistic resistant material enclosed within a case comprises one of a Kevlar fabric piece, an ultra high molecular weight polyethylene piece, and a polyethylene plate.

5. The backpack of claim 3 wherein each of the plurality of layers of ballistic resistant material enclosed within a case comprises a Kevlar fabric piece coated with a shear-thickening fluid.

6. The backpack of claim 3 wherein at least one of the plurality of layers of ballistic resistant material enclosed within the case comprises a thin pouch of magnetorheological fluid that changes its ballistic resistance when subjected to a magnetic field provided.

7. The backpack of claim 6 wherein the case comprises an electrical coil or mesh that when provided with electrical power from the powerbank charger generates a magnetic field sufficient to cause the thin pouch of magnetorheological fluid to harden enough to provide ballistic resistance.

8. The backpack of claim 1 further comprising:
a plurality of cameras, each of the plurality of cameras communicatively coupled to the electronic circuitry and, when triggered, collecting audio and video data and communicating it to an external receiver via the electronic circuitry.

9. The backpack of claim 1 further comprising:
the electronic circuitry comprises a processor communicatively coupled to a communications circuitry, wherein the communications circuitry is capable of NFC and wifi communications for communicating data collected and streaming videos;
the processor to communicatively and electrically coupled the powerbank charger for electrical power;
the processor facilitating near-field and wifi communications employing the communications circuitry; and
the processor conducting automated and triggered mode monitoring, data collection, and live streaming employing video streams collected by a camera disposed on the backpack.

10. A backpack with shoulder straps that allow it to be carried on one's back or across one's chest, the backpack comprising:
a bulletproof backpanel that provides personal security;
a processor communicatively coupled to a communications circuitry, wherein the communications circuitry is capable of NFC and wifi communications;
the processor communicating data collected and streaming videos via the communications circuitry; and
the processor triggering rheological behavior in the bulletproof backpanel based on user activation, external commands or anticipated security threats.

11. The backpack of claim 10 wherein the processor, based on user trigger received, commences data collection and live streaming of video provided by a camera communicatively coupled to the processor.

12. The backpack of claim 10 wherein the backpack reports its current location to an external server and mobile device.

13. The backpack of claim 10 wherein the backpack reports shots heard.

14. The backpack of claim 10 wherein the backpack starts and stops collecting and reporting data and video based on user commands and based on remote instructions received.

15. The backpack of claim 10 wherein the backpack also comprises a RFID secure packet where credit cards and passports can be securely stored without the possibility of unauthorized access to their credit card numbers and passport data while they are being thus stored.

16. A backpack for personal security with a backpanel made from a material for dissipating the kinetic energy of a moving object that impinges upon the backpack, the backpack comprising:
the backpanel comprising a plurality of layers of the material, each of the plurality of layers of the material being additionally covered or impregnated with shear thickening fluid; and
the backpanel also comprising a camera communicatively coupled to a processor to provide live streaming of video when triggered; and
the processor configured to activate data collection and camera live streaming automatically based on monitoring the environment, and also activation on receiving remote commands.

17. The backpack of claim 16 wherein said material is one of a kevlar fabric and ultra high molecular weight polyethylene plate.

18. The backpack of claim 16 wherein said material is impregnated with particles suspended in a solvent and said particle-solvent suspension remains in a flowable form after impregnation.

19. The backpack of claim 16 wherein material for dissipating the kinetic energy of a moving object comprises a material which is made of fiber or yarn and said fiber or said yarn is impregnated with a shear thickening fluid wherein said shear thickening fluid remains in a fluid form in said material.

20. The backpack of claim 16 further comprising:
an audio command circuitry that monitors audio signals to detect commands and instructions and upon detecting, triggers a corresponding activity.
